(19) United States
(12) Patent Application Publication
(10) Pub. No.: US 2025/0378379 A1
(43) Pub. Date: Dec. 11, 2025

(54) INFORMATION PROCESSING APPARATUS, ANALYSIS METHOD, AND STORAGE MEDIUM

(71) Applicant: NEC Corporation, Tokyo (JP)

(72) Inventors: Naoki YOSHINAGA, Tokyo (JP); Michimasa IRIE, Tokyo (JP)

(73) Assignee: NEC Corporation, Tokyo (JP)

(21) Appl. No.: 19/221,747

(22) Filed: May 29, 2025

(30) Foreign Application Priority Data
Jun. 7, 2024 (JP) 2024-093255

(51) Int. Cl. G06N 20/00

(52) U.S. Cl. CPC G06N 20/00

(57) ABSTRACT

In order to make use of content easier, an information processing apparatus includes: an acquisition unit that acquires a plurality of pieces of content which are comparison targets; and an extraction unit that extracts, with use of an extraction model which has been generated by machine learning so as to be capable of extracting a comparison target portion in content, a comparison target portion in the plurality of pieces of content that have been acquired by the acquisition unit. It is possible to use, for decision making based on the pieces of content which were used as comparison targets, a result of extraction by the extraction unit.

This Nonprovisional application claims priority under 35 U.S.C. § 119 on Patent Application No. 2024-093255 filed in Japan on Jun. 7, 2024, the entire contents of which are hereby incorporated by reference.

### TECHNICAL FIELD

The present disclosure relates to an information processing apparatus, an analysis method, and a storage medium.

### BACKGROUND ART

In recent years, various kinds of content are used for various tasks. For example, in marketing of products and services, an analysis target(s) may be content of web pages, reviews, and/or the like for various products and services that are not only in a field to which a product or a service that one desires to develop belongs but also in other fields. Further, for example, each company prepares and publishes a report in which details of activities of that company are summarized. Such a task for preparing a report is performed with reference to various kinds of content which includes, in addition to a material that indicates the details of activities of the company, a past report of the company and a report of another company.

In this case, examples of a technology that is considered to be usable in using the content include a search apparatus disclosed in Patent Literature 1 below. This search apparatus has a function of specifying and extracting, from documents that are stored in a database, a document that predicts future. This search apparatus is considered to be usable for extracting a document to be referenced, for example, in a case where a report that mentions the future of company activities is prepared.

### CITATION LIST

### Patent Literature

### [Patent Literature 1]

Japanese Patent Application Publication Tokukai No. 2016-206751

### SUMMARY OF INVENTION

### Technical Problem

However, the function of the search apparatus disclosed in Patent Literature 1 is limited to detection of a specific document that predicts the future. Thus, the function can be used only for a specific purpose such as preparation of a report that mentions the future, and lacks versatility. On this account, in many cases, in order to use content for some task, it has been necessary for a person to carry out the following operations: read content that may relate to the task; identify related parts; and compare and examine matters described in the related parts that have been identified. Such operations require a lot of time and effort.

The present disclosure has been made in view of the above, and an example object of the present disclosure is to provide a technology that makes it possible to more easily use content.

### Solution to Problem

An information processing apparatus in accordance with an example aspect of the present disclosure includes at least one processor, the at least one processor carrying out: an acquisition process of acquiring a plurality of pieces of content which are of comparison targets; and an extraction process extracting, with use of an extraction model which has been generated by machine learning so as to be capable of extracting a comparison target portion in content, a comparison target portion in the plurality of pieces of content that have been acquired in the acquisition process.

An analysis method in accordance with an example aspect of the present disclosure includes: an acquisition process in which at least one processor acquires a plurality of pieces of content which are comparison targets; and an extraction process in which the at least one processor extracts, with use of an extraction model which has been generated by machine learning so as to be capable of extracting a comparison target portion in content, a comparison target portion in the plurality of pieces of content that have been acquired in the acquisition process.

A storage medium in accordance with an example aspect of the present disclosure stores an analysis program for causing a computer to carry out: an acquisition process of acquiring a plurality of pieces of content which are comparison targets; and an extraction process of extracting, with use of an extraction model which has been generated by machine learning so as to be capable of extracting a comparison target portion in content, a comparison target portion in the plurality of pieces of content that have been acquired in the acquisition process.

### Advantageous Effects of Invention

An example aspect of the present disclosure yields an example advantage of making it possible to more easily use content.

### BRIEF DESCRIPTION OF DRAWINGS

FIG. 1 is a block diagram illustrating a configuration of an information processing apparatus in accordance with the present disclosure.

FIG. 2 is a flowchart illustrating a flow of an analysis method in accordance with the present disclosure.

FIG. 3 is a block diagram illustrating a configuration of another information processing apparatus in accordance with the present disclosure.

FIG. 4 is a diagram illustrating an example of extraction of an assertion point dealing with a matter that is different between a plurality of pieces of content which are comparison targets.

FIG. 5 is a flowchart illustrating an example of a flow of a series of processes which are carried out by the information processing apparatus illustrated in FIG. 3.

FIG. 6 is a diagram illustrating an example of extraction of elements that constitute a time series from a plurality of pieces of content which are comparison targets.

FIG. 7 is a diagram illustrating an example of extraction of another element that constitutes the time series from reference information.

FIG. 8 is a diagram illustrating an example of use of an information processing apparatus 1A for comparative analysis of a plurality of subjects.

FIG. 9 is a flowchart illustrating another example of a flow of a series of processes which are carried out by the information processing apparatus illustrated in FIG. 3.

FIG. 10 is a diagram illustrating an example of generating, on the basis of a plurality of pieces of content that are comparison targets, new content in which elements that are in those pieces of contents and that constitute a time series are integrated with each other.

FIG. 11 is a flowchart illustrating still another example of a flow of a series of processes which are carried out by the information processing apparatus illustrated in FIG. 3.

FIG. 12 is a diagram illustrating an example of analysis of a plurality of pieces of content that describe respective different subjects.

FIG. 13 is a flowchart illustrating still another example of a flow of a series of processes which are carried out by the information processing apparatus illustrated in FIG. 3.

FIG. 14 is a block diagram illustrating a configuration of a computer which functions as the information processing apparatus in accordance with the present disclosure.

### DESCRIPTION OF EMBODIMENTS

The following description will discuss example embodiments of the present invention. Note, however, that the present invention is not limited to the example embodiments described below, but can be altered in various ways by a person skilled in the art within the scope of the claims. For example, the present invention can also encompass, in its scope, any example embodiment derived by appropriately combining technologies/techniques (some or all of products or processes) employed in the example embodiments described below. Further, the present invention can also encompass, in its scope, any example embodiment derived by appropriately omitting some of the technologies/techniques employed in the example embodiments described below. Furthermore, example advantages mentioned in the example embodiments described below are example effects expected in the example embodiments described below, and are not intended to define an extension of the present invention. That is, the present invention can also encompass, in its scope, any example embodiment that does not bring about any of the example advantages mentioned in the example embodiments described below.

### First Example Embodiment

The following description will discuss a first example embodiment, which is an example embodiment of the present invention, in detail with reference to the drawings. The present example embodiment is a basic form of example embodiments described later. Note that the scope of application of technologies/techniques which are employed in the present example embodiment is not limited to the present example embodiment. That is, the technologies/techniques which are employed in the present example embodiment can be employed also in the other example embodiments included in the present disclosure, provided that no particular technical problem occurs. Moreover, technologies/techniques which are indicated in the drawings referred to for describing the present example embodiment can be employed also in the other example embodiments included in the present disclosure, provided that no particular technical problem occurs.

### (Configuration of Information Processing Apparatus 1)

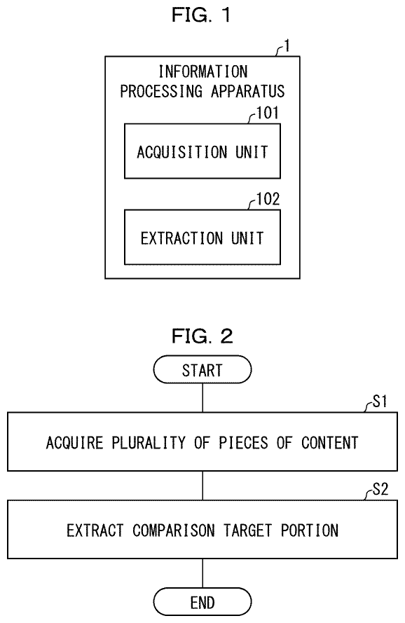

A configuration of an information processing apparatus 1 in accordance with the present example embodiment will be described with reference to FIG. 1. FIG. 1 is a block diagram illustrating the configuration of the information processing apparatus 1. As illustrated in FIG. 1, the information processing apparatus 1 includes an acquisition unit 101 and an extraction unit 102.

The acquisition unit 101 acquires a plurality of pieces of content which are comparison targets. Here, the pieces of contents which are comparison targets each may be any content in which a matter that is a comparison target is expressed. For example, the content may be a document, that is, text format content, image content, or content including both of text and an image. Further, the image content includes moving image content and/or static image content. Moreover, the acquisition unit 101 may acquire a plurality of independent pieces of content or may acquire, as the plurality of pieces of content, portions of a single piece of content. In the latter case, the acquisition unit 101 may acquire, as the pieces of content which comparison are targets, respective chapters of document content that consists of a plurality of chapters. In addition, the “comparison target” can be read as “analysis target”, “examination target”, or the like.

The extraction unit 102 extracts, with use of an extraction model which has been generated by machine learning so as to be capable of extracting a comparison target portion in content, a comparison target portion in the plurality of pieces of content that have been acquired by the acquisition unit 101.

The “extraction model” may be any model that is generated by machine learning so as to be capable of extracting a comparison target portion from content. For example, in a case where the content which is a target is text format content, a language model that has learned, by machine learning, an arrangement of components (such as words) of a sentence and an arrangement of sentences in text may be applied as the extraction model. Furthermore, for example, in a case where content which is a target is image content, it is possible to apply, as the extraction model, a model which has learned, by machine learning, a relationship between image data and a comparison target portion in the target that is expressed by the image data. In addition, it is possible to apply, as the extraction model, a combination of (a) a generative model of text data that generates, from image data, text data which indicates a matter dealt with in the image data and (b) an extraction model that extracts, from the text data, a comparison target portion.

Further, in a case where content which is a target is in a format other than text, the extraction unit 102 may perform the above-described extraction after converting that content into a text format. For example, in a case where content which is a target is image data, the extraction unit 102 may generate text data with use of a generative model that generates text indicating the target expressed by the image data. Then, the extraction unit 102 may extract, with use of a language model, a comparison target portion from the text data. Furthermore, for example, in a case where content which is a target is audio data, the extraction unit 102 may convert the sound data into text data and then extract, with use of a language model, a comparison target portion from the text data. Note that a process for converting the content into the text format may be carried out: by the acquisition unit 101; by providing, in the information processing apparatus 1, a block that is different from the acquisition unit 101 and the extraction unit 102, and causing the block to carry out the process; or by causing another apparatus other than the information processing apparatus 1 to carry out the process.

As described above, the information processing apparatus 1 in accordance with the present example embodiment employs a configuration including: an acquisition unit 101 that acquires a plurality of pieces of content which are comparison targets; and an extraction unit 102 that extracts, with use of an extraction model which has been generated by machine learning so as to be capable of extracting a comparison target portion in content, a comparison target portion in the plurality of pieces of content that have been acquired by the acquisition unit 101.

Conventionally, in a case where a plurality of pieces of content are to be used for various tasks, it has been necessary for a person to read each piece of content and identify a comparison target portion in the each content. With regard to this point, it is not necessary for a user of the information processing apparatus 1 to read content which is a comparison target or to identify a comparison target portion. The user of the information processing apparatus 1 can easily use content, since a comparison target portion is extracted by simply inputting, to the information processing apparatus 1, the content which is a comparison target. Thus, the information processing apparatus 1 achieves an example advantage of making it possible to more easily use content.

Note that a result of extraction by the extraction unit 102 can be used in various applications. For example, the information processing apparatus 1 may present the result of extraction to a user of the information processing apparatus 1. This allows the user to easily recognize the comparison target portion in each of the plurality of pieces of content. The result of extraction can also be used in decision making based on the pieces of content which were used as comparison targets. For example, the information processing apparatus 1 can use, as comparison targets, respective reports on business plans that are published by a plurality of competitors, and can extract “Field of Focus in Future” as a comparison target portion in each of those reports. A result of such extraction can be a reference, for example, in a case where a business plan of a company is determined in light of fields of focus of the competitors.

Note that use of the result of extraction is not limited to presentation to a user. For example, it is possible to carry out processes such as a process of automatically carrying out various analyses with use of a result of extraction or a process of generating new content with user of a result of extraction.

### (Analysis Program)

Functions of the information processing apparatus 1 above can be realized by a program. An analysis program in accordance with the present example embodiment causes a computer to function as: an acquisition means that acquires a plurality of pieces of content which are comparison targets; and an extraction means that extracts, with use of an extraction model which has been generated by machine learning so as to be capable of extracting a comparison target portion in content, a comparison target portion in the plurality of pieces of content that have been acquired by the acquisition means. This analysis program achieves an example advantage of making it possible to more easily use content.

### (Flow of Analysis Method)

A flow of an analysis method in accordance with the present example embodiment will be described below with reference to FIG. 2. FIG. 2 is a flowchart illustrating the flow of the analysis method. Note that steps of the analysis method may be carried out by a processor of the information processing apparatus 1 or by a processor of another apparatus. Alternatively, the steps may be carried out by processors provided in respective different apparatuses.

In S1 (acquisition process), at least one processor acquires a plurality of pieces of content which are comparison targets.

In S2 (extraction process), the at least one processor extracts, with use of an extraction model which has been generated by machine learning so as to be capable of extracting a comparison target portion in content, a comparison target portion in the plurality of pieces of content that have been acquired in S1.

As described above, in the analysis method in accordance with the present example embodiment employs a configuration in which at least one processor carries out: an acquisition process of acquiring the a plurality of pieces of content which are comparison targets; and an extraction process of extracting, with use of an extraction model which has been generated by machine learning so as to be capable of extracting a comparison target portion in content, a comparison target portion from the plurality of pieces of content that have been acquired in the acquisition process. Thus, the analysis method in accordance with the present example embodiment achieves an example advantage of making it possible to more easily use content.

### Second Example Embodiment

The following description will discuss a second example embodiment, which is an example embodiment of the present invention, in detail with reference to the drawings. A component having the same function as a component described in the above example embodiment is assigned the same reference sign, and the description thereof is omitted where appropriate. Note that the scope of application of technologies/techniques which are employed in the present example embodiment is not limited to the present example embodiment. That is, the technologies/techniques which are employed in the present example embodiment can be employed also in the other example embodiments included in the present disclosure, provided that no particular technical problem occurs. Moreover, technologies/techniques which are indicated in the drawings referred to for describing the present example embodiment can be employed also in the other example embodiments included in the present disclosure, provided that no particular technical problem occurs.

### (Configuration of Information Processing Apparatus 1A)

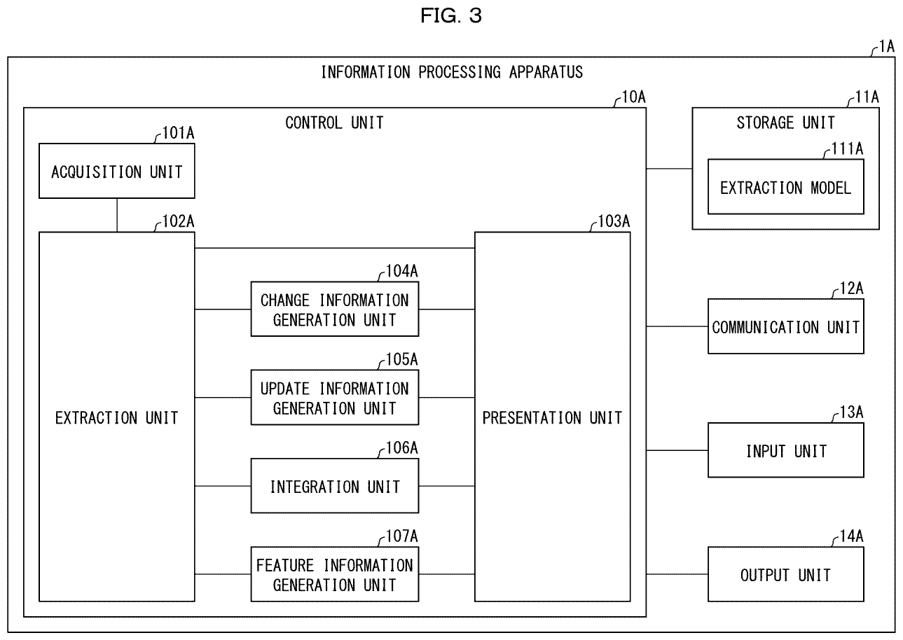

A configuration of an information processing apparatus 1A in accordance with the present example embodiment will be described below with reference to FIG. 3. FIG. 3 is a block diagram illustrating the configuration of the information processing apparatus 1A. The information processing apparatus 1A is an apparatus having a function of supporting use of content. The information processing apparatus 1A may be an apparatus whose main function is to support use of content, or may be a general-purpose apparatus which additionally has other functions. The information processing apparatus 1A may be a stationary apparatus or a portable apparatus.

As illustrated in FIG. 3, the information processing apparatus 1A includes: a control unit 10A that performs overall control of units of the information processing apparatus 1A; and a storage unit 11A that stores various data to be used by the information processing apparatus 1A. The information processing apparatus 1A further includes a communication unit 12A that allows the information processing apparatus 1A to communicate with another apparatus, an input unit 13A that receives input to the information processing apparatus 1A, and an output unit 14A that allows the information processing apparatus 1A to output data. Further, the control unit 10A includes: an acquisition unit 101A, an extraction unit 102A, a presentation unit 103A, a change information generation unit 104A, an update information generation unit 105A, an integration unit 106A, and a feature information generation unit 107A. An extraction model 111A is stored in the storage unit 11A. Note that the change information generation unit 104A, the update information generation unit 105A, the integration unit 106A, and the feature information generation unit 107A will be described in detail later.

The acquisition unit 101A acquires a plurality of pieces of content which are comparison targets, similarly to the acquisition unit 101 in the first example embodiment. As in the first example embodiment, the pieces of content which are comparison targets each may be any content in which a matter that is a comparison target is expressed, and each may also be in any format.

The extraction unit 102A extracts, with use of an extraction model 111A which has been generated by machine learning so as to be capable of extracting a comparison target portion in content, a comparison target portion in the plurality of pieces of content that have been acquired by the acquisition unit 101A, similarly to the extraction unit 102 in the first example embodiment. The following description will discuss an example of applying, as the extraction model 111A, a language model which has learned, by machine learning, an arrangement of components of a sentence and an arrangement of sentences in text. Note that, as described in the first example embodiment, the extraction model 111A that is used for extraction of a comparison target portion may be any model that is generated by machine learning so as to be capable of extracting a comparison target portion in content. Thus, the extraction model 111A is not limited to a language model.

The presentation unit 103A presents, to a user of the information processing apparatus 1A, a result of extraction by the extraction unit 102A, that is, the comparison target portion that is in the plurality of pieces of content which are comparison targets and that is extracted from the plurality of pieces of content. Note that an example aspect of presentation of the result of extraction is not particularly limited. For example, the presentation unit 103A may output the result of extraction by display, sound, or printing. Moreover, what apparatus is used to display the result of extraction is not particularly limited. For example, the presentation unit 103A may cause the output unit 14A provided in the information processing apparatus 1A to output the result of extraction, or may cause an apparatus external to the information processing apparatus 1A (for example, a terminal apparatus used by a user) to output the result of extraction.

As described above, the information processing apparatus 1A in accordance with the present example embodiment employs a configuration including: an acquisition unit 101A that acquires a plurality of pieces of content which are comparison targets; and an extraction unit 102A that extracts, with use of an extraction model 111A which has been generated by machine learning so as to be capable of extracting a comparison target portion in content, a comparison target portion in the plurality of pieces of content that have been acquired by the acquisition unit 101A. Thus, the information processing apparatus 1A can provide an example advantage of making it possible to more easily use content, similarly to the information processing apparatus 1 in accordance with the first example embodiment.

### (Example 1 of Extraction: Extraction of Different Assertion Point/Common Assertion Point)

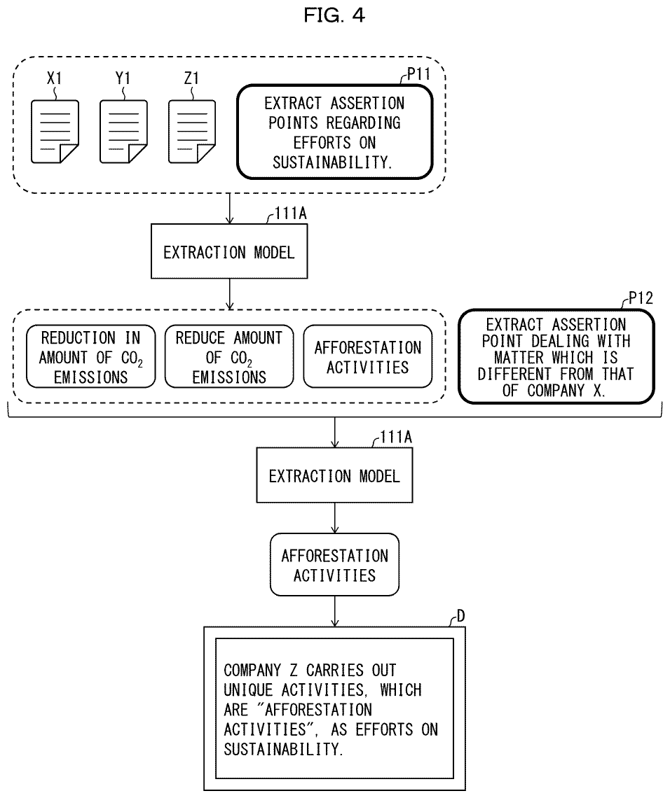

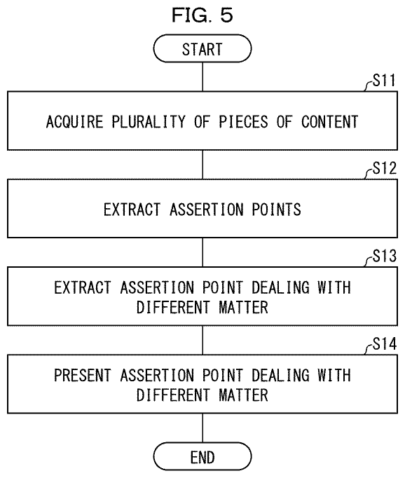

The extraction unit 102A may extract, as a comparison target portion, at least one selected from the group consisting of (i) an assertion point dealing with a matter that is common between a plurality of pieces of content and (ii) an assertion point dealing with a matter that is different between the plurality of pieces of content, the at least one assertion point being extracted from among respective assertion points that are asserted in the plurality of pieces of content which are acquired by the acquisition unit 101A. This configuration achieves, in addition to the example advantage yielded by the information processing apparatus 1, an example advantage of making it possible to easily carry out analysis and the like based on matters asserted in pieces of content. Extraction of an assertion point dealing with a matter that is common or different between a plurality of pieces of content will be described below with reference to FIGS. 4 and 5.

FIG. 4 is a diagram illustrating an example of extraction of an assertion point dealing with a matter that is different between a plurality of pieces of content which are comparison targets. In the example of FIG. 4, the acquisition unit 101A acquires, as pieces of content which are comparison targets, reports (sustainability reports) X1, Y1, and Z1. The reports are on efforts on sustainability and were prepared respectively by Company X, Company Y, and Company Z. Each of the reports X1, Y1, and Z1 is content including text and may include an image(s) such as a graph and/or an illustration.

After the reports X1, Y1, and Z1 are acquired, the extraction unit 102A inputs, to the extraction model 111A, the report X1 and a prompt P11 that instructs the extraction model 111A to extract an assertion point regarding the efforts on sustainability. This leads to extraction of an assertion point regarding the efforts on sustainability from the report X1. Further, the extraction unit 102A similarly extracts, from each of the reports Y1 and Z1, an assertion point regarding the efforts on sustainability. In the example of FIG. 4, the assertion point “reduction in amount of CO₂ emissions” is extracted from the report X1, the assertion point “reduce amount of CO₂ emissions” is extracted from the report Y1, and “afforestation activities” is extracted from the report Z1.

Note that, in a case where all of the reports X1, Y1, and Z1 have been prepared in accordance with a predetermined format, the extraction unit 102A may carry out extraction in which an item that is specified in the format is a target of the extraction. This makes it possible to improve extraction accuracy. For example, in a case where the predetermined format includes the item “Matters regarding efforts on sustainability”, the extraction unit 102A may carry out extraction with use of a prompt that instructs extraction from the item.

Further, in a case where the reports X1, Y1, and Z1 contain images, the extraction unit 102A may generate text that describes the images, and then extract, from the text, an assertion point regarding the efforts on sustainability. For example, in a case where the report X1 includes a graph that indicates changes in amount of CO₂ emissions, the extraction unit 102A may input the graph to a generative model that generates an explanation of an image from the image, and thus, generate text (e.g., the amount of CO₂ emissions is reduced, or the like) that indicates the changes in amount of CO₂ emissions. This allows the extraction unit 102A to extract an assertion point regarding the efforts on sustainability from the text generated.

Next, in the information processing apparatus 1A, the assertion points of the reports X1, Y1, and Z1 that have been extracted as described above are analyzed. More specifically, the extraction unit 102A inputs, to the extraction model 111A, each of the assertion points that have been extracted as described above and a prompt P12 which instructs the extraction model 111A to extract an assertion point dealing with a matter which is different from that of the assertion point of Company X. This leads to extraction of the assertion point “afforestation activities” of Company Z, which deals with a matter that is different from that dealt with by the assertion point “reduction in amount of CO₂ emissions” of Company X. On the other hand, the assertion point “reduce amount of CO₂ emissions” of Company Y is not extracted. This is because, although there is a difference in expression between this assertion point and the assertion point “reduction in amount of CO₂ emissions” of Company X, matters dealt with in these assertion points are the same each other.

Note that a process of extracting the assertion points from the reports X1 to Z1 and a process of extracting an assertion point that is different from another assertion point from among the assertion points that have been extracted may be carried out with use of one extraction model 111A or may be carried out with use of respective different extraction models 111A. In this way, for different extraction processes, one extraction model 111A may be used or respective different extraction models 111A may be used. In the example of FIG. 4, two prompts P11 and P12 are sequentially used for extraction of an assertion point. However, it is possible to extract an assertion point dealing with a matter that is different between a plurality of pieces of content with use of a single prompt that includes the two prompts P11 and P12. For example, the extraction unit 102A can extract, in a single extraction process, an assertion point “afforestation activities” of Company Z, with use of a prompt that reads “extract an assertion point that is different from the assertion point of Company X, from the assertion points of Company Y and Company Z with regard to efforts on sustainability”. These matters are the same for each of examples which will be described later.

Next, the presentation unit 103A presents, to a user of the information processing apparatus 1A, the result of extraction by the extraction unit 102A. In the example of FIG. 4, the presentation unit 103A presents the result of extraction by causing a display apparatus D to display text that indicates the result of extraction by the extraction unit 102A. It is possible to generate such text with use of, for example, a template or to cause a language model (the extraction model 111A may be used also for this purpose) to generate the text.

Note that the information processing apparatus 1A can carry out the above-described process for various kinds of content. For example, a plurality of pieces of content in which exercises that are effective for maintaining a healthy state are described can be input to the information processing apparatus 1A and then, the exercises that are asserted as effective in those pieces of content can be extracted as the assertion points. Then, it is possible to further extract and present an assertion point which is common between the plurality of pieces of content from among the assertion points that have been extracted. This makes it possible to present, to a user, an exercise which is supported by a plurality of pieces of content and which can be expected to be highly effective. In this way, the information processing apparatus 1A can be used in a health care application.

### (Example 1 of Flow of Series of Processes: Extraction of Different Assertion Point/Common Assertion Point)

An example of a flow of a series of processes which are carried out by the information processing apparatus 1A will be described below with reference to FIG. 5. FIG. 5 is a flowchart illustrating an example of a flow of a series of processes which are carried out by the information processing apparatus 1A, and more specifically, a flowchart illustrating an example of a flow of a series of processes of extracting an assertion point dealing with a matter that is different between a plurality of pieces of content. The flow of FIG. 5 includes steps of the analysis method in accordance with the present example embodiment.

In S11 (acquisition process), the acquisition unit 101A acquires a plurality of pieces of content which are comparison targets. A method of acquiring the content is not particularly limited. For example, the acquisition unit 101A may acquire content that is inputted via the input unit 13A or may acquire, via the communication unit 12A, content that is stored in a storage device external to the information processing apparatus 1A. In the latter case, a user of the information processing apparatus 1A may be caused to designate a storage destination of the content which is a comparison target. Moreover, the user may also be allowed to designate conditions of extraction (e.g., what assertion point is to be extracted, whether to extract a different assertion point, whether to extract a common assertion point, and/or the like).

In S12 and S13 (extraction process), the extraction unit 102A extracts, with use of the extraction model 111A, a comparison target portion in the plurality of pieces of content that have been acquired in S11. Note that, in a case where the conditions for extraction are designated, the extraction unit 102A carries out extraction according to the conditions.

More specifically, in S12, with use of the extraction model 111A, the extraction unit 102A extracts, from each of the plurality of pieces of content that have been acquired in S11, an assertion point that is asserted in each of the pieces of content. Note that, in S12, the extraction unit 102A may extract a plurality of assertion points from one piece of content. Further, in S12, the extraction unit 102A may extract an assertion point without use of the extraction model 111A. For example, in a case where each of the plurality of piece of content has been prepared in accordance with a predetermined format, an item in which an assertion point to be extracted is described is also fixed. Thus, the extraction unit 102A may extract, as the item in which the assertion point is described, a predetermined item in each of the plurality of pieces of content.

In S13, with use of the extraction model 111A, the extraction unit 102A extracts, as a comparison target portion, an assertion point dealing with a matter that is different between the plurality of pieces of content from among the assertion points that have been extracted in S12. Note that in S13, the extraction unit 102A may extract an assertion point dealing with a matter that is common between the plurality of pieces of content. Further, the extraction unit 102A may extract both of an assertion point dealing with a matter that is different between the plurality of pieces of content and an assertion point dealing with a matter that is common between the plurality of pieces of content.

In S14, the presentation unit 103A presents, to the user, the assertion point that has been extracted in S13. For example, as in the example of FIG. 4, the presentation unit 103A may present, to the user, the assertion point by causing the display apparatus D to display the assertion point that has been extracted. Then, the series of processes of FIG. 5 ends.

(Example 2 of Extraction: Extraction of Elements that Constitute Time Series)

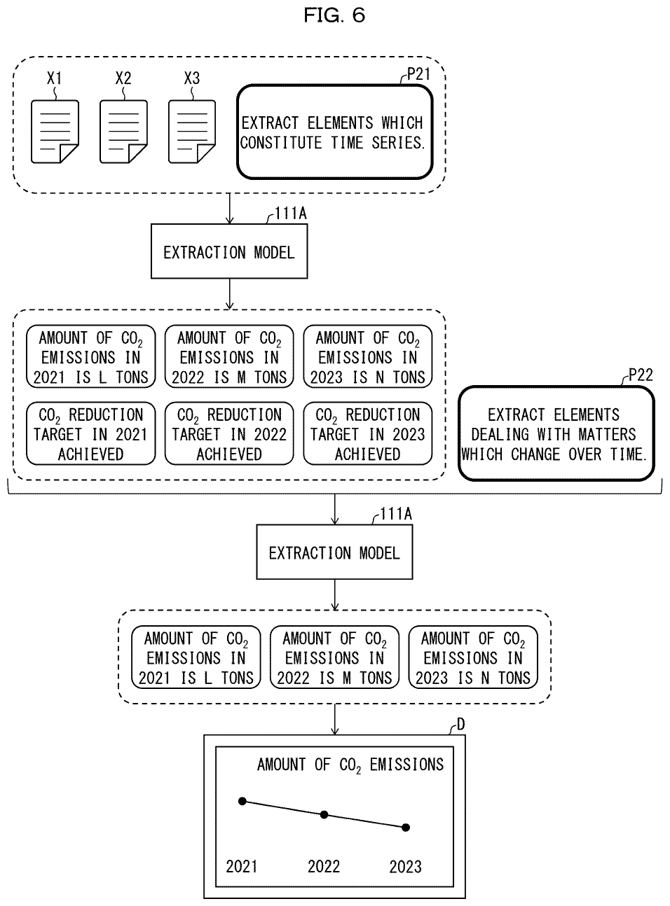

The extraction unit 102A may extract, as a comparison target portion, an element that constitute a time series from elements that are contained in each of the plurality of pieces of content which have been acquired by the acquisition unit 101A. This configuration achieves, in addition to the example advantage yielded by the information processing apparatus 1, an example advantage of making it possible to carry out analysis and the like based on the time series. Extraction of elements that constitute a time series will be described below with reference to FIGS. 6 to 9.

FIG. 6 is a diagram illustrating an example of extraction of elements that constitute a time series from a plurality of pieces of content which are comparison targets. In the example of FIG. 6, the acquisition unit 101A acquires, as pieces of content which are comparison targets, a plurality of reports X1 to X3 that were prepared by X company. Each of the reports X1 to X3 describes the same subject (specifically, efforts on sustainability by Company X), but years for which the reports X1 to X3 were prepared differs from each other. Specifically, the report X1 is a report for the year 2021, and reports X2 and X3 are reports for the years 2022 and 2023, respectively.

Next, the extraction unit 102A inputs, to the extraction model 111A, the reports X1 to X3 that have been acquired and a prompt P21 that instructs the extraction model 111A to extract, from elements which are included in the reports X1 to X3, elements which constitute a time series. Thus, the elements that constitute the time series are extracted from the reports X1 to X3. In the example of FIG. 6, the amount of CO₂ emissions and the achievement status of the CO₂ reduction target in respective years are extracted from the reports X1 to X3.

In the example of FIG. 6, further analysis is carried out with use of a result of the above extraction. Specifically, the extraction unit 102A inputs, to the extraction model 111A, the elements that have been extracted as described above and a prompt P22 that instructs the extraction model 111A to extract elements dealing with matters which change over time. This leads to extraction of descriptions of the amount of CO₂ emissions that changes each year from among descriptions on the amount of CO₂ emissions and the achievement status of the CO₂ reduction target that have been extracted earlier.

Here, the change information generation unit 104A generates, for the elements that the extraction unit 102A have extracted as described above, change information that indicates changes of the elements. This configuration achieves, in addition to the example advantage yielded by the information processing apparatus 1, an example advantage of making it possible to easily carry out analysis and the like based on changes of elements that constitute a time series and that are included in respective pieces of content.

The change information may be any information that indicates changes of elements. For example, the change information may indicates changes of elements by text, by an image, or by a combination of text and an image. In the example of FIG. 6, the change information generation unit 104A generates, as the change information, a line graph which indicates changes in the amount of CO₂ emissions, and the presentation unit 103A causes the display apparatus D to display the line graph generated. A method of generating the change information is not particularly limited. For example, the change information generation unit 104A may generate the change information with use of a language model (an extraction model 111A may be used also for this purpose) or may generate the change information with use of a generative model for generating a graph.

(Extraction of Elements that Constitute Time Series from Reference Information)

The extraction unit 102A extracts elements that constitute a time series as described above. Thereafter, the extraction unit 102A may extract another element which constitutes the time series with the elements, from reference information that describes the another element. This achieves, in addition to the effect yielded by the information processing apparatus 1, an example advantage of making it possible to easily extract another element that constitutes a time series with elements (that constitute the time series) that have been extracted from a plurality of pieces of content which are comparison target.

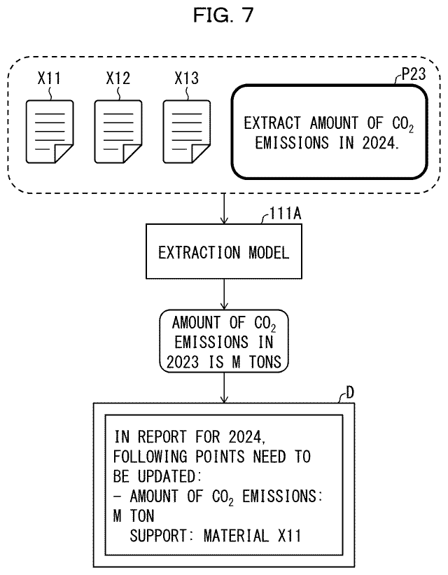

Extracting, from reference information, another element that constitutes a time series will be described below with reference to FIG. 7. FIG. 7 is a diagram illustrating an example of extraction of another element that constitutes a time series from reference information. Note that FIG. 7 shows an example in which another element is extracted from the reference information with regard to amounts of CO₂ emissions in respective years out of the elements which have been extracted in the example of FIG. 6.

In the example of FIG. 7, the reference information is information that is contained in materials X11 to X13 and that indicates the latest efforts on sustainability of Company X. The materials X11 to X13 are, for example, documents that include text. The materials X11 to X13 each may include an image(s) such as a graph and/or an illustration. Note that the number and format of materials which include information to be used as the reference information are arbitrary. For example, a database to which reference is made may be designated and information in each material (which may be also reworded as content) in the database may be used as the reference information.

In the example of FIG. 7, the extraction unit 102A inputs, to the extraction model 111A, the materials X11 to X13 and a prompt P23 that instructs the extraction model 111A to extract another element that constitutes the time series with the elements that have been extracted earlier from those materials. Specifically, the elements that have been extracted earlier are the amounts of CO₂ emissions from 2021 to 2023. Then, another element which the extraction model 111A is instructed to further extract is the amount of CO₂ emissions in 2024, that is, the another element that constitutes the time series with the amounts of CO₂ emissions from 2021 to 2023. Thus, in the example illustrated in FIG. 7, a description which indicates that the amount of CO₂ emissions in 2024 was M tons has been extracted from the material X11. Note that a period for which a description is to be extracted may be determined in advance or may be designated by a user.

Next, the update information generation unit 105A generates, from a result of extraction by the extraction unit 102A, update information which indicates an update matter for updating the reports X1 to X3 and which is to be in a new report (specifically, a report for the year 2024) that will be prepared on the basis of the materials X11 to X13. Then, the presentation unit 103A presents, to a user of the information processing apparatus 1A, the update information thus generated.

In the example of FIG. 7, the presentation unit 103A causes the display apparatus D to display the update information that has been generated by the update information generation unit 105A. This update information indicates that in the report for the year 2024, the amount of CO₂ emissions needs to be updated to “M tons” and also that the basis for this update is the material X11. Thus, the update information may also present, together with the update matter, information that indicates a source from which the element has been extracted. This makes it possible to for a user to more easily carry out an operation of checking validity of the update matter.

Similarly, for elements that are associated with “achievement status of the CO₂ reduction target” in respective years and that are extracted in the example of FIG. 6, the extraction unit 102A can also extract, from the materials X11 to X13 and as another element that constitutes the time series with those elements, a description that indicates the achievement status in 2024. Further, the extraction unit 102A can also extract a description of year other than 2024 (for example, a description prior to 2021 or a description of a portion of a period from 2021 to 2023).

In addition, the update information generation unit 105A can also generate, on the basis of content which is a comparison target, new content that constitutes a time series with the content. For example, the update information generation unit 105A can generate a report for the year 2024 by updating, on the basis of the result of extraction by the extraction unit 102A, the description of each item included in the reports for the years 2021 to 2023. Further, it is possible to automatically update, by the update information generation unit 105A, a description which changes over time, for example, in a web page.

### (Comparative Analysis by Comparison of Plurality of Subjects)

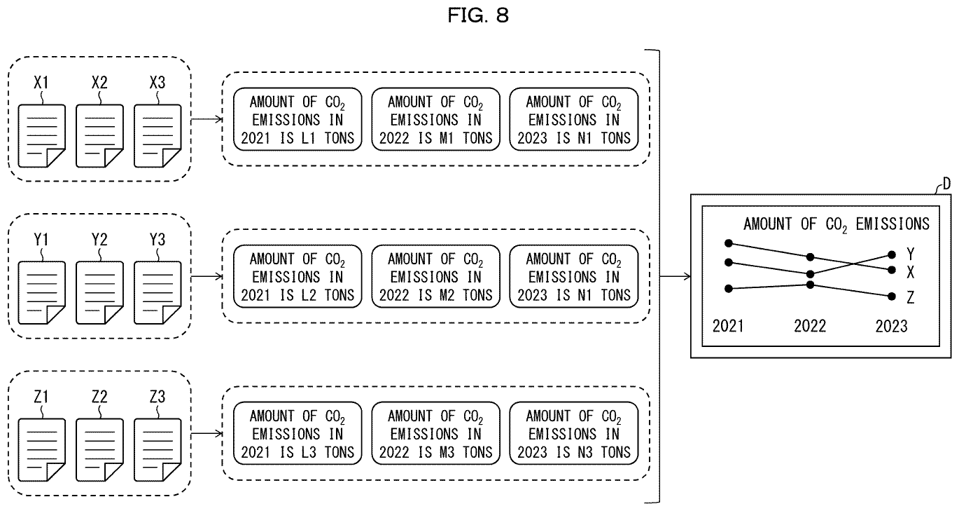

The information processing apparatus 1A can also be used for comparative analysis of a plurality of subjects. This will be described below with reference to FIG. 8. FIG. 8 is a diagram illustrating an example of use of the information processing apparatus 1A for comparative analysis of a plurality of subjects. More specifically, FIG. 8 shows an example in which three companies including Companies X, Y, and Z are subjects of analysis and in which comparative analysis of changes of the amount of amount of CO₂ emissions is carried out.

Content which is a comparison target in the example of FIG. 8 includes reports X1 to X3 that Company X prepared, reports Y1 to Y3 that Company Y prepared, and reports Z1 to Z3 that Company Z prepared. Then, as in the example of FIG. 6, descriptions that indicate the amount of CO₂ emissions of Company X from 2021 to 2023 are extracted from the reports X1 to X3. Similarly, descriptions that indicate the amount of CO₂ emissions of Company Y from 2021 to 2023 are extracted from the reports Y1 to Y3 and descriptions that indicate the amount of CO₂ emissions of Company Z from 2021 to 2023 are extracted from the reports Z1 to Z3.

Here, the change information generation unit 104A generates, from the above-described descriptions that have been extracted, change information that indicates respective changes in the amount of CO₂ emissions of the above companies. Then, the presentation unit 103A presents thus generated pieces of the change information in association with each other. Specifically, in the example of FIG. 8, for each of the companies X, Y, and Z, the change information generation unit 104A generates, as the change information, a line graph which indicates changes in the amount of CO₂ emissions, and the presentation unit 103A causes the display apparatus D to display the line graph generated.

As described above, the change information generation unit 104A may generate the change information for each of the plurality of subjects. In this case, the presentation unit 103A may present generated respective pieces of change information for the plurality of subjects in association with each other. This configuration achieves, in addition to the example advantage yielded by the information processing apparatus 1, an example advantage of making it possible to more easily carry out, for a plurality of subjects, comparative analysis of elements that change over time. For example, by inputting, to the information processing apparatus 1A, an investor relations (IR) material as the content which is a comparison target, it is also possible to easily carry out comparative analysis of respective trends of the companies.

(Example 2 of Flow of Series of Processes: Extraction of Elements that Constitute Time Series)

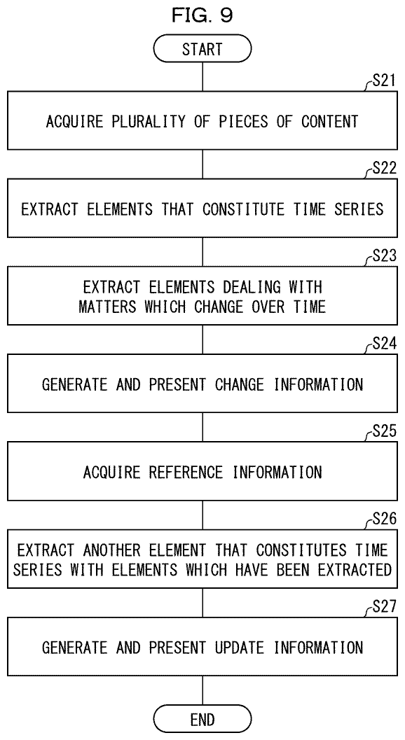

Another example of a flow of a series of processes which are carried out by the information processing apparatus 1A will be described below with reference to FIG. 9. FIG. 9 is a flowchart illustrating another example of the flow of the series of processes carried out by the information processing apparatus 1A. More specifically, FIG. 9 shows an example of the series of processes in a case where elements that constitute a time series are extracted. The flow of FIG. 9 includes steps of the analysis method in accordance with the present example embodiment, as in the example of FIG. 5.

In S21 (acquisition process), the acquisition unit 101A acquires a plurality of pieces of content which are comparison targets. Here, a plurality of pieces of content each including an element that constitutes a time series are acquired. For example, the acquisition unit 101A may acquire a plurality of pieces of content that describe the same subject but that differ from each other in timing at which the content was created. Note that the acquisition unit 101A may acquire, as the plurality of pieces of content, portions that include elements constituting a time series among constituent elements of a single piece of content. As an example, the acquisition unit 101A may acquire, as the pieces of content which are comparison targets, portions describing matters on activities in respective months in a report that reports matters on activities for a year. Note that a method of acquiring the content is not particularly limited, as in the example of FIG. 5. Further, in S21, it is possible to also receive designation of a condition for extraction (e.g., what element is to be extracted or the like).

In S22 (extraction process), with use of the extraction model 111A, the extraction unit 102A extracts, as a comparison target portion, each of elements that constitute a time series from respective elements that are included in the plurality of pieces of content which have been acquired in S21.

In S23, the extraction unit 102A extracts, from the elements that have been extracted in S22, elements dealing with matters which change over time. In S23, the extraction unit 102A may extract, with use of the extraction model 111A, elements dealing with matters which change over time, as in the example of FIG. 6. Further, in a case where the elements that have been extracted in S22 have the same text except for a numerical value, the extraction unit 102A may extract, as the elements dealing with matters which change over time, a difference between the elements that have been extracted in S22. For example, in a case where the extraction unit 102A extracts, in S22, expressions of “the amount of CO₂ emissions in 2021 is L1 tons” and “the amount of CO₂ emissions in 2022 is M1 tons”, it is possible to extract, as the elements dealing with matters which change over time, “2021” and “2022” and “L1” and “M1” which are differences between those descriptions.

In S24, the change information generation unit 104A generates, for the elements that have been extracted in S23, change information that indicates changes the elements. Then, the presentation unit 103A presents, to a user, the change information thus generated. Note that, in S23, in a case where elements of which not numerical values but described matters change are extracted, the change information generation unit 104A may generate change information that indicates changes of the described matters. For example, the change information generation unit 104A may input, to a language model (the extraction model 111A may be used also for this purpose), the elements that have been extracted in S23, and generate change information which summarizes the described matters of the elements. For example, in a case where descriptions that read “efforts to save electricity were started in 2021” and “the efforts to save electricity were strengthened in 2022” are extracted, it is possible to generate, as the change information, a sentence that reads “the efforts to save electricity that was started in 2021 was enhanced in 2022” may be generated.

In S25, the acquisition unit 101A acquires reference information which describes about the elements that have been extracted in S22. This reference information is information for generating new content that constitutes a time series with the plurality of pieces of content that have been acquired in S21. The reference information includes another element that constitutes a time series with the elements that has been extracted in S22. For example, assume that in a case where (i) a plurality of pieces of content that have been acquired in S21 are reports for respective years including the years 2021 to 2023 and (ii) new content to be generated is a report for the year 2024, “amounts of CO₂ emissions” in the respective years have been extracted in S22. In this case, in S25, reference information including information that indicates the amount of CO₂ emissions in 2024 is acquired. Note that a method of acquiring the reference information is not particularly limited, as in the acquisition process in S21.

In S26, the extraction unit 102A extracts, from the reference information that has been acquired in S25, another element that constitutes the time series with the elements which have been extracted in S22. Further, in S27, the update information generation unit 105A generates, from a result of extraction in S26, update information which indicates an update matter for updating the plurality of pieces of content having been acquired in S21 and which is to be in new content that will be created on the basis of the reference information having been acquired in S25. Thereafter, the presentation unit 103A presents, to the user, the update information thus generated. Then, the series of processes of FIG. 9 ends.

Note that the processes S21 to S23 may be carried out for each of the plurality of subjects. As a result, in S24, it is possible to generate change information for each of the plurality of subjects, and present a plurality of generated pieces of change information in association with each other. Further, in a case where it is not necessary to generate new content, the processes S25 to S27 are omitted.

(Example 3 of Extraction: Generation of New Content in which Elements that Constitute Time Series are Integrated)

The integration unit 106A generates new content in which the elements that constitute the time series and that are extracted by the extraction unit 102A are integrated with each other. The information processing apparatus 1A including the integration unit 106A achieves, in addition to the effect yielded by the information processing apparatus 1, an example advantage of making it possible to automatically generate new content in which elements that constitute a time series are integrated with each other.

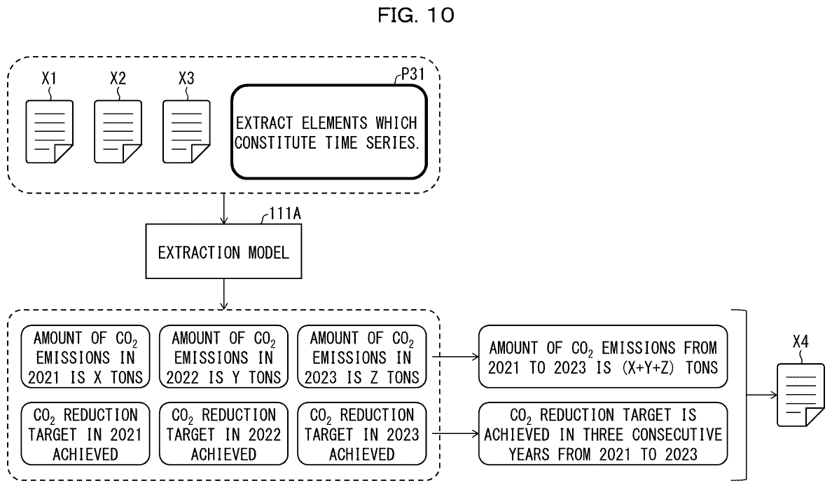

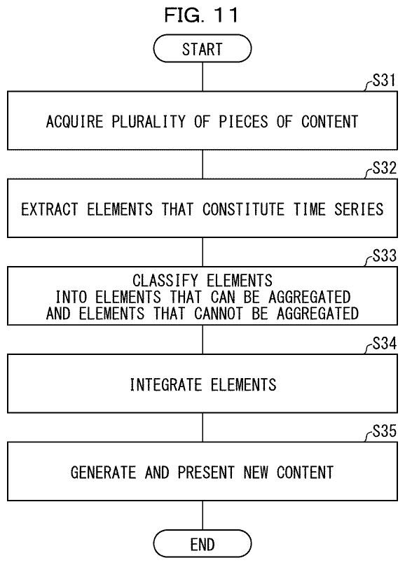

Generation of new content in which elements that constitute a time series are integrated with each other will be described below with reference to FIGS. 10 and 11. FIG. 10 is a diagram illustrating an example of generating, on the basis of a plurality of pieces of content that are comparison targets, new content in which elements that are in those pieces of content and that constitute a time series are integrated with each other. In the example of FIG. 10, as in the example of FIG. 6, the acquisition unit 101A acquires, as pieces of content which are comparison targets, the reports X1 to X3 that constitute a time series, and then, the extraction unit 102A extracts, from the reports X1 to X3, elements that constitute a time series (the amount of CO₂ emissions for each year and the achievement status of the CO₂ reduction target for each year).

The integration unit 106A integrates, with each other, the elements thus extracted. Specifically, in the example of FIG. 10, the integration unit 106A generates, from descriptions of the amount of CO₂ emissions extracted, a description that reads “the amount of CO₂ emissions from 2021 to 2023 is (X+Y+Z) tons”. In this way, with regard to elements whose described matters can be aggregated among elements that constitute a time series, the integration unit 106A may integrate those elements with each other by aggregating the described matters.

Note that a method of aggregation is arbitrary. For example, a sum of numerical values may be used as a result of aggregation as in the example above, or statistical values such as an average value, a median value, and a mode value may be each used as a result of aggregation. Such aggregation can be carried out, for example, with use of a rule base in which the aggregation method is set as rules, or with use of a language model (the extraction model 111A may be used also for this purpose).

Meanwhile, in the example of FIG. 10, the integration unit 106A generates, from respective extracted descriptions on the achievement status of the CO₂ reduction target, a description that reads “the CO₂ reduction target is achieved in three consecutive years from 2021 to 2023”. In this way, with regard to elements whose described matters cannot be aggregated among the elements that constitute the time series, the integration unit 106A may integrate, by summarizing the described matters, the elements whose described matters cannot be aggregated. Such integration can be carried out with use of, for example, a language model (the extraction model 111A may be used also for this purpose). Further, the integration unit 106A may integrate the elements with each other by enumerating each of the elements that have been extracted.

As described above, the integration unit 106A integrates, with each other, the elements that are described in the reports X1 to X3 and that constitute the time series, and generates new content that includes the elements which have been integrated with each other. In the example of FIG. 10, a report X4 that includes the above integrated description is generated.

For example, the integration unit 106A may use, as content which serves as a base for the report X4, any of the reports X1 to X3 (for example, the report X3 which was prepared in the latest year among these reports). Then, the integration unit 106A may generate the report X4 by replacing, with an integrated element, a constituent element that corresponds to the above-described integrated element among constituent elements of the content. For example, in the example of FIG. 10, the integration unit 106A may generate the report X4, by (i) replacing a description that reads “the amount of CO₂ emissions in 2023 is Z tons” in the report X3 with a description that reads “the amount of CO₂ emissions from 2021 to 2023 is (X+Y+Z) tons” and (ii) also replacing a description that reads “the CO₂ reduction target is achieved in 2023” in the report X3 with a description that reads “the CO₂ reduction target is achieved in three consecutive years from 2021 to 2023”.

Further, in a case where the reports X1 to X3 are each prepared with use of a common template, the integration unit 106A may generate the report X4 by inputting an integrated element into the template. In this case, the integration unit 106A may extract, from the reports X1 to X3, other elements that are to be inputted to the template.

Note that the integration unit 106A may integrate, as targets, elements which change over time among the elements which constitute the time series. In this case, the extraction unit 102A may first extract the elements which constitute the time series, and then extract a difference between the elements. Then, the integration unit 106A may integrate the elements with each other, on the basis of the difference thus extracted. Also in this case, it is preferable to aggregate elements that can be aggregated.

(Example 3 of Flow of Series of Processes: Generation of New Content in which Elements that Constitute Time Series are Integrated)

FIG. 11 is a flowchart illustrating still another example of a flow of a series of processes which are carried out by the information processing apparatus 1A. More specifically, FIG. 11 is a flowchart illustrating an example of a flow of a series of processes in which new content is generated by integrating elements that constitute a time series. The flow of FIG. 11 also includes the steps of the analysis method in accordance with the present example embodiment, as in FIG. 5 and the like.

In S31 (acquisition process), the acquisition unit 101A acquires a plurality of pieces of content which are comparison targets. Here, a plurality of pieces of content which are targets to be integrated and which constitute a time series are acquired. Alternatively, the acquisition unit 101A may acquire, as the plurality of pieces of content, portions that include elements constituting a time series among constituent elements of a single piece of content. In this case, it is possible to generate content in which the elements that constitute the time series and that are included in the single piece of content are integrated with each other. Note that a method of acquiring the content is not particularly limited as in the example of FIG. 5 and the like. Further, in S31, it is possible to also receive designation of a condition for extraction (e.g., what element is to be extracted or the like).

In S32 (extraction process), with use of the extraction model 111A, the extraction unit 102A extracts, as a comparison target portion, each of elements that constitute a time series from respective elements that are included in the plurality of pieces of content which have been acquired in S31.

In S33, the integration unit 106A classifies the elements which have been extracted in S32 into elements that can be aggregated and elements that cannot be aggregated. A method of this classification is arbitrary. For example, the integration unit 106A may classify, into elements that can be aggregated, a series of elements which constitute a time series and all of which include respective numerical values, and may classify, into elements that cannot be aggregated, a series of elements which include an element that does not include a numerical value.

In S34, the integration unit 106A integrates, with each other, the elements which constitute the time series and which have been extracted in S32. At this time, the integration unit 106A aggregates described matters for the elements that have been classified in S33 such that the elements can be aggregated, and summarizes the described matters for elements that have been classified in S33 such that the elements cannot be aggregated. Note that, as described above, the integration unit 106A does not necessarily need to summarize the described matters, but, for example, may integrate the elements with each other by enumerating each of the element.

In S35, the integration unit 106A generates new content that includes the elements that have been integrated in S34. Thereafter, the presentation unit 103A presents, to a user, the content generated. Then, the series of processes of FIG. 11 ends. Note that it is not essential to present the content generated. For example, the content generated may be stored in the storage unit 11A, and with this storage, the series of processes may be ended. Alternatively, the content generated may be transmitted to a terminal apparatus of the user, and then the series of processes may be ended.

### (Example 4 of Extraction: Analysis of Subjects Described by Content)

The plurality of pieces of content which the information processing apparatus 1A uses as comparison targets and each of which describes a subject which is different for each of the plurality of pieces of content. In this case, the extraction unit 102A may extract, as a comparison target portion, an assertion point dealing with a matter that is different between the plurality of pieces of content, from among respective assertion points that are asserted in the plurality of pieces of content which are acquired by the acquisition unit 101A. Then, the presentation 103A may present the assertion point that the extraction unit 102A has extracted from the plurality of pieces of content, as information that indicates a feature of a subject which is described in the content from which the assertion point is extracted.

This configuration achieves, in addition to the example advantage yielded by the information processing apparatus 1, an example advantage of making it possible to easily carry out analysis and the like of a feature of a subject. This is because a unique assertion point for a given subject can be regarded as a feature of that subject. Note that the subject which is described by content may be anything, and may be, for example, a product, a service, a person, a region, a country, or the like.

Further, the extraction unit 102A may extract, as a comparison target portion, an assertion point dealing with a matter that is common between the plurality of pieces of content, from among respective assertion points that are asserted in the plurality of pieces of content which have been acquired by the acquisition unit 101A. In this case, the feature information generation unit 107A generates, by using an assertion point which the extraction unit 102A has extracted from the plurality of pieces of content, feature information which indicates a feature that is common between subjects described by the plurality of pieces of content from which the assertion point is extracted. This configuration achieves, in addition to the example advantage yielded by the information processing apparatus 1, an example advantage of making it possible to easily carry out analysis and the like of a feature that is common between subjects.

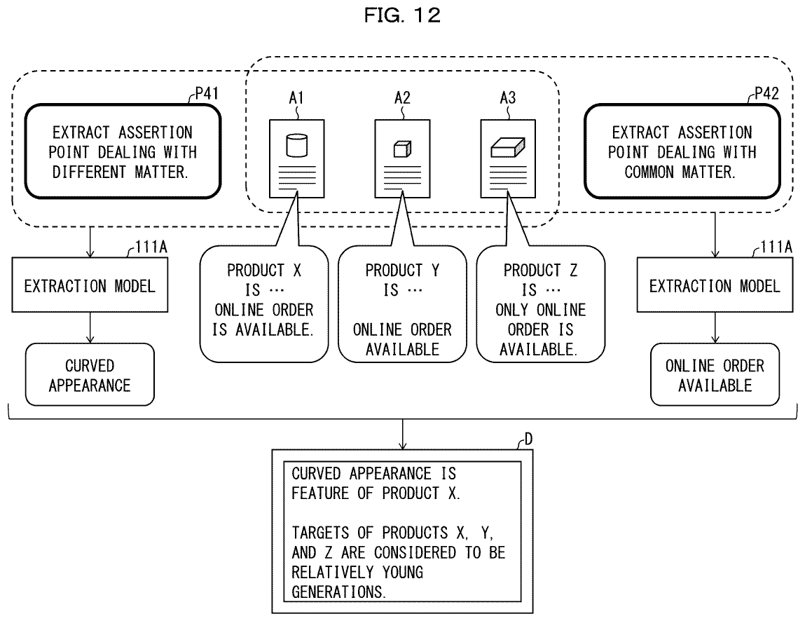

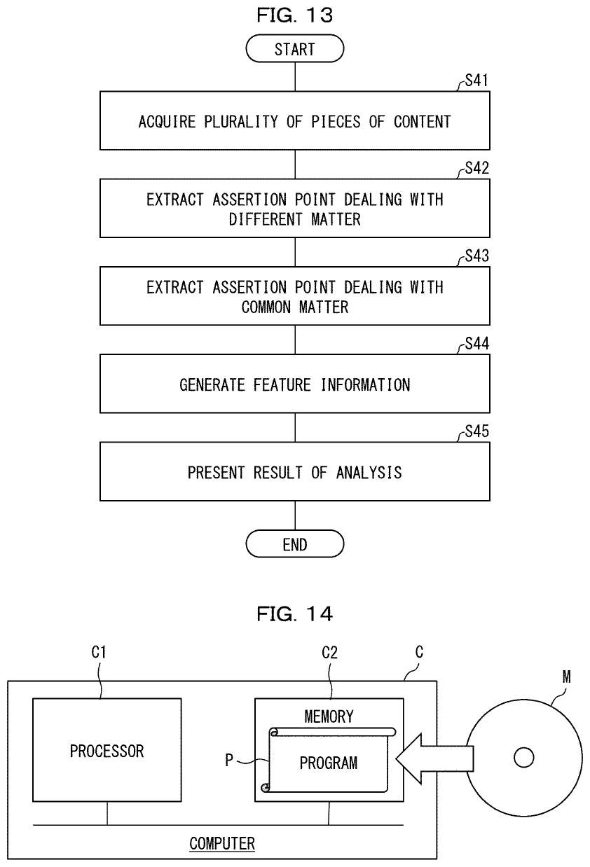

Thus, the information processing apparatus 1A can be used for analysis of a subject which is described by content. This analysis will be described below with reference to FIGS. 12 and 13. FIG. 12 is a diagram illustrating an example of analysis of a plurality of pieces of content that describe respective different subjects. In the example of FIG. 12, the acquisition unit 101A acquires, as the pieces of content which are comparison targets, pieces of content A1 to A3 which respectively describe the products X, Y, and Z. The pieces of content A1 to A3 may be, for example, web pages that advertise the products X, Y, and Z. Further, in the example of FIG. 12, the content A1 includes an image of the product X which has a cylindrical appearance and description text of the product X. In the description text, it is described that online order is available. Further, the content A2 includes an image of the product Y which has a cubic appearance and description text of the product Y. In the description text, it is described that an online order is available. Further, the content A3 includes an image of the product Z which has a rectangular parallelepiped appearance and description text of the product Z. In the description text, it is described that an online order is available.

In the example of FIG. 12, the extraction unit 102A inputs, to the extraction model 111A, acquired pieces of content A1 to A3 and a prompt P41. The prompt P41 instructs the extraction model 111A to extract, from respective assertion points that are asserted in the pieces of content A1 to A3, an assertion point which deal with a matter that is different between the pieces of content A1 to A3. Thus, in the example of FIG. 12, an assertion point of a “curved appearance” is extracted from the content A1. This assertion point may be extracted from an explanatory sentence, that is, text which is included in the content A1, or may be extracted from an image that is included in the content A1.

Then, the presentation unit 103A causes the display apparatus D to display the assertion point of the “curved appearance” which is extracted by the extraction unit 102A, as information that indicates the feature of the product X described by the content A1 from which the assertion point is extracted. Thus, a user who uses the information processing apparatus 1A can easily ascertain features of products, by simply inputting content which includes information on each of the products that the user desires to analyze. Note that text that describes the assertion point extracted may be generated by inputting, to a template that has been prepared in advance, the assertion point that has been extracted, or may be generated by a language model (the extraction model 111A may be used also for this purpose).

Further, in the example of FIG. 12, the extraction unit 102A inputs, to the extraction model 111A, acquired pieces of content A1 to A3 and a prompt P42. The prompt P42 describes a matter for instructing the extraction model 111A to extract, from the respective assertion points that are asserted in the pieces of content A1 to A3, assertion points which deal with a matter that is common between the pieces of content A1 to A3. Thus, in the example of FIG. 12, an assertion point of “online order available” is extracted.

Here, the feature information generation unit 107A generates, by using the assertion point of “online order available” which the extraction unit 102A has extracted from the pieces of content A1 to A3, feature information that indicates a feature that is common between the products X, Y, and Z described by the pieces of content A1 to A3 from which the assertion point is extracted. A method of generating the feature information is not particularly limited. For example, the feature information generation unit 107A may generate the feature information with use of a rule base or may generate the feature information by inputting, to a template that has been prepared in advance, the assertion point that has been extracted. Furthermore, for example, the feature information generation unit 107A may cause a language model (the extraction model 111A may be used also for this purpose) to generate the feature information. For the feature example, information generation unit 107A can generate feature information that indicates a target user image of a product, by inputting, to the language model, the assertion point that has been extracted and in addition, a prompt that makes an inquiry on a target user image of the product having such an assertion point. The presentation unit 103A may be caused to present the feature information generated. For example, the presentation unit 103A may cause the display apparatus D to display the feature information, as in the example of FIG. 12.

### (Example 4 of Flow of Series of Processes: Analysis of Subject Described by Content)

FIG. 13 is a flowchart illustrating still another example of a flow of a series of processes which are carried out by the information processing apparatus 1A. More specifically, FIG. 13 is a flowchart illustrating an example of a flow of a series of processes for a case in which a plurality of pieces of content that describe respective different subjects are analyzed. The flow of FIG. 13 also includes the steps of the analysis method in accordance with the present example embodiment, as in FIG. 5 and the like.

In S41 (acquisition process), the acquisition unit 101A acquires a plurality of pieces of content that describe respective different subjects. Note that the acquisition unit 101A may acquire, as the plurality of pieces of content, portions that describe respective different subjects among constituent elements of a single piece of content. Further, a method of acquiring the content is not particularly limited as in the example of FIG. 5 and the like. Further, in S41, it is possible to also receive designation of a condition for extraction (e.g., what assertion point is to be extracted), on the basis of what viewpoint feature information is to be generated, and/or the like.

In S42 (extraction process), with use of the extraction model 111A, the extraction unit 102A extracts, as a comparison target portion, an assertion point dealing with a matter that is different between the plurality of pieces of content which have been acquired in S41.

In S43 (extraction process), with use of the extraction model 111A, the extraction unit 102A extracts, as a comparison target portion, an assertion point dealing with a matter that is common between the plurality of pieces of content which have been acquired in S41. Note that the order of execution of the processes of S42 and S43 is arbitrary, and that the process of S43 may be carried out before the process of S42. Further, in a case where respective different extraction models 111A are used in S42 and S43, it is possible to carry out the processes of S42 and S43 in parallel with each other.

In S44, the feature information generation unit 107A generates, by using an assertion point which has been extracted in S43, feature information that indicates a feature that is common between the subjects described by the plurality of pieces of content from which the assertion point is extracted.

In S45, the presentation unit 103A presents, to a user, a result of analysis in S42 to S44. For example, the presentation unit 103A presents, to the user, the feature information that has been generated in S44, for example, by causing a display apparatus to display the feature information. Also, the presentation unit 103A may present the assertion point that has been extracted in S42, as information that indicates a feature of a subject described in content from which the assertion point has been extracted. Then, the series of processes in FIG. 13 ends.

Note that it is not essential to present a result of analysis. For example, the result of analysis may be stored in the storage unit 11A, and then the series of processes may be ended. Alternatively, the content generated may be transmitted to a terminal apparatus of the user, and then the series of processes may be ended. Further, in the example of FIG. 13, carried out are both of (a) extraction the assertion point dealing with the matter that is common between the plurality of pieces of content and (b) extraction of the assertion point dealing with the matter that is different between the plurality of pieces of content. However, only the extraction (a) or (b) may be carried out. In a case where extraction of the assertion point dealing with the matter that is common between the plurality of pieces of content is not carried out, the process of S44 is also omitted.

Further, the assertion point having the matter that is common and the assertion point having the matter that is different may be extracted by a plurality of steps. For example, in the first step, the extraction unit 102A may extract an assertion point of each piece of content. Next, in the second step, the extraction unit 102A may extract, from among extracted assertion points, an assertion point regarding a common subject matter (for example, in a case where the target is a product, an appearance, a price, a function, and/or the like). Then, in the third step, the extraction unit 102A may extract, from among the assertion points that have been extracted, the assertion point having the matter that is different or that is common.

### Variation

The processes described in the foregoing example embodiments may be carried out by any subject, which is not limited to the foregoing examples. For example, a system having functions similar to those of the information processing apparatus 1, 1A can be constructed by a plurality of apparatuses that can communicate with each other. The processes shown in the flowcharts illustrated in FIGS. 5, 9, 11, and 13 may be carried out by a single apparatus (that can be reworded as a processor) or by a plurality of apparatuses (that can be also reworded as processors).

### [Software Implementation Example]

Some or all of the functions of the information processing apparatus 1, 1A can be realized by hardware integrated circuit (IC chip), or can be such as an realized by software.

In the latter case, the information processing apparatus 1 or 1A is realized by, for example, a computer that executes instructions of a program that is software realizing the foregoing functions. FIG. 14 illustrates an example of such a computer (hereinafter referred to as “computer C”). FIG. 14 is a block diagram illustrating a hardware configuration of the computer C which functions as the information processing apparatus 1 or 1A.

The computer C includes at least one processor C1 and at least one memory C2. In the memory C2, a program (analysis program) P for causing the computer C to operate as the information processing apparatus 1 or 1A is recorded. In the computer C, the functions of the information processing apparatus 1 or 1A are realized by the processor C1 reading the program P from the memory C2 and executing the program P.

Examples of the processor C1 encompass a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, and a combination thereof. Examples of the memory C2 include a flash memory, a hard disk drive (HDD), a solid state drive (SSD), and a combination thereof.

Note that the computer C may further include a random access memory (RAM) in which the program P is loaded during execution of the program P and/or in which various kinds of data are temporarily stored. The computer C may further include a communication interface via which the computer C transmits and receives data to and from another apparatus. The computer C may further include an input/output interface via which the computer C is connected to an input/output apparatus(es) such as a keyboard, a mouse, a display, and/or a printer.

The program P can be stored in a non-transitory tangible storage medium M which is readable by the computer C. Examples of the storage medium M encompass a tape, a disk, a card, a semiconductor memory, and a programmable logic circuit. The computer C can acquire the program P via the storage medium M. The program P can be transmitted via a transmission medium. Examples of the transmission medium encompass a communications network and a broadcast wave. The computer C can acquire the program P also via such a transmission medium.

The foregoing functions of the information processing apparatuses 1 and 1A may be realized by a single processor provided in a single computer, may be realized by cooperation by a plurality of processors provided in a single computer, or may be realized by cooperation by a plurality of processors provided in a respective plurality of computers. A program for causing the information processing apparatuses 1 and 1A to realize the foregoing functions may be stored in a single memory provided in a single computer, may be stored dispersedly in a plurality of memories provided in a single computer, or may be stored dispersedly in a plurality of memories provided in a respective plurality of computers.

### Additional Remarks

The present disclosure includes techniques described in supplementary notes below. Note, however, that the present invention is not limited to the techniques described in the supplementary notes below, but may be altered in various ways by a skilled person within the scope of the claims.

### (Supplementary Note A1)

An information processing apparatus including: an acquisition means that acquires a plurality of pieces of content which are comparison targets; and an extraction means that extracts, with use of an extraction model which has been generated by machine learning so as to be capable of extracting a comparison target portion in content, a comparison target portion in the plurality of pieces of content that have been acquired by the acquisition means.

### (Supplementary Note A2)

The information processing apparatus according to supplementary note A1, wherein, from among respective assertion points that are asserted in the plurality of pieces of content, the extraction means extracts, as the comparison target portion, at least one selected from the group consisting of (i) an assertion point dealing with a matter that is common between the plurality of pieces of content and (ii) an assertion point dealing with a matter that is different between the plurality of pieces of content.

### (Supplementary Note A3)

The information processing apparatus according to supplementary note A1, wherein, from elements that are contained in the plurality of pieces of content, the extraction means extracts, as the comparison target portion, each of elements that constitute a time series.

### (Supplementary Note A4)

The information processing apparatus according to supplementary note A3, wherein, from reference information that describes the elements that constitute the time series, the extraction means extracts an element that constitutes the time series together with the elements that have been extracted.

### (Supplementary Note A5)

The information processing apparatus according to supplementary note A3 or A4, further including a change information generation means that generates, for the elements that constitute the time series and that have been extracted by the extraction means, change information that indicates changes of the elements.

### (Supplementary Note A6)

The information processing apparatus according to supplementary note A5, further including a presentation means, the change information generation means generating the change information for each of a plurality of subjects, and the presentation means associating, with each other, respective pieces of the change information that correspond to the plurality of subjects and presenting the pieces of the change information.

### (Supplementary Note A7)

The information processing apparatus according to any one of supplementary notes A3 to A6, further including an integration means that generates new content in which the elements that constitute the time series and that have been extracted by the extraction means are integrated with each other.

### (Supplementary Note A8)

The information processing apparatus according to supplementary note A1, further including a presentation means, the plurality of pieces of content each describing a subject which is different for each of the plurality of pieces of content, from among respective assertion points that are asserted in the plurality of pieces of content, the extraction means extracting, as the comparison target portion, an assertion point dealing with a matter that is different between the plurality of pieces of content, and the presentation means presenting the assertion point that has been extracted from the plurality of pieces of content by the extraction means, as information indicating a feature of the subject that is described in the content from which the assertion point is extracted.

### (Supplementary Note A9)

The information processing apparatus according to supplementary note A1, further including a feature information generation means, the plurality of pieces of content describing respective different subjects, from among respective assertion points that are asserted in the plurality of pieces of content, the extraction means extracting, as the comparison target portion, an assertion point dealing with a matter that is common between the plurality of pieces of content, and the feature information generation means generating feature information, with use of the assertion point that has been extracted from the plurality of pieces of content by the extraction means, the feature information indicating a feature that is common between the respective different subjects that are described in the plurality of pieces of content from which the assertion point is extracted.

### (Supplementary Note B1)

An analysis method including: an acquisition process in which at least one processor acquires a plurality of pieces of content which are comparison targets; and an extraction process in which the at least one processor extracts, with use of an extraction model which has been generated by machine learning so as to be capable of extracting a comparison target portion in content, a comparison target portion in the plurality of pieces of content that have been acquired in the acquisition process.

### (Supplementary Note B2)

The analysis method according to supplementary note B1, wherein, in the extraction process, from among respective assertion points that are asserted in the plurality of pieces of content, the at least one processor extracts, as the comparison target portion, at least one selected from the group consisting of (i) an assertion point dealing with a matter that is common between the plurality of pieces of content and (ii) an assertion point dealing with a matter that is different between the plurality of pieces of content.

### (Supplementary Note B3)

The analysis method according to supplementary note B1, wherein, in the extraction process, from elements that are contained in the plurality of pieces of content, the at least one processor extracts, as the comparison target portion, each of elements that constitute a time series.

### (Supplementary Note B4)

The analysis method according to supplementary note B3, wherein, in the extraction process, from reference information that describes the elements that constitute the time series, the at least one processor extracts an element that constitutes the time series together with the elements that have been extracted.

### (Supplementary Note B5)

The analysis method according to supplementary note B3 or B4, wherein the at least one processor carries out a information change generation process of generating, for the elements that constitute the time series and that have been extracted in the extraction process, change information that indicates changes of the elements.

### (Supplementary Note B6)

The analysis method according to supplementary note B5, wherein:
in the change information generation process, the at least one processor generates the change information for each of a plurality of subjects; and
the at least one processor carries out a presentation process of associating, with each other, respective pieces of the change information that correspond to the plurality of subjects and presenting the pieces of the change information.

### (Supplementary Note B7)

The analysis method according to any one of supplementary notes B3 to B6, wherein the at least one processor carries out an integration process of generating new content in which the elements that constitute the time series and that have been extracted in the extraction process are integrated with each other.

### (Supplementary Note B8)

The analysis method according to supplementary note B1, wherein: the plurality of pieces of content each describe a subject which is different for each of the plurality of pieces of content; in the extraction process, from among respective assertion points that are asserted in the plurality of pieces of content, the at least one processor extracts, as the comparison target portion, an assertion point dealing with a matter that is different between the plurality of pieces of content; and the at least one processor carries out a presentation process of presenting the assertion point that has been extracted from the plurality of pieces of content in the extraction process, as information indicating a feature of the subject that is described in the content from which the assertion point is extracted.

### (Supplementary Note B9)

The analysis method according to supplementary note B1, wherein: the plurality of pieces of content describe respective different subjects; in the extraction process, from among respective assertion points that are asserted in the plurality of pieces of content, the at least one processor extracts, as the comparison target portion, an assertion point dealing with a matter that is common between the plurality of pieces of content; and the at least one processor carries out a feature information generation process of generating, with use of the assertion point that has been extracted from the plurality of pieces of content in the extraction process, feature information indicating a feature that is common between the respective different subjects that are described in the plurality of pieces of content from which the assertion point is extracted.

### (Supplementary Note C1)

An analysis program for causing a computer to function as: an acquisition means that acquires a plurality of pieces of content which are comparison targets; and an extraction means that extracts, with use of an extraction model which has been generated by machine learning so as to be capable of extracting a comparison target portion in content, a comparison target portion in the plurality of pieces of content that have been acquired by the acquisition means.

### (Supplementary Note C2)

The analysis program according to supplementary note C1, wherein, from among respective assertion points that are asserted in the plurality of pieces of content, the extraction means extracts, as the comparison target portion, at least one selected from the group consisting of (i) an assertion point dealing with a matter that is common between the plurality of pieces of content and (ii) an assertion point dealing with a matter that is different between the plurality of pieces of content.

### (Supplementary Note C3)

The analysis program according to supplementary note C1, wherein, from elements that are contained in the plurality of pieces of content, the extraction means extracts, as the comparison target portion, each of elements that constitute a time series.

### (Supplementary Note C4)

The analysis program according to supplementary note C3, wherein, from reference information that describes the elements that constitute the time series, the extraction means extracts an element that constitutes the time series together with the elements that have been extracted.

### (Supplementary Note C5)

The analysis program according to supplementary note C3 or C4, for causing the computer to further function as a change information generation means that generates, for the elements that constitute the time series and that have been extracted by the extraction means, change information that indicates changes of the elements.

### (Supplementary Note C6)

The analysis program according to supplementary note C5, for causing the computer to further function as a presentation means, the change information generation means generating the change information for each of a plurality of subjects, and the presentation means associating, with each other, respective pieces of the change information that correspond to the plurality of subjects and presenting the pieces of the change information.

### (Supplementary Note C7)

The analysis program according to any one of supplementary notes C3 to C6, for causing the computer to further function as an integration means that generates new content in which the elements that constitute the time series and that have been extracted by the extraction means are integrated with each other.

### (Supplementary Note C8)

The analysis program according to supplementary note C1, for causing the computer to further function as a presentation means, the plurality of pieces of content each describing a subject which is different for each of the plurality of pieces of content, from among respective assertion points that are asserted in the plurality of pieces of content, the extraction means extracting, as the comparison target portion, an assertion point dealing with a matter that is different between the plurality of pieces of content, and the presentation means presenting the assertion point that has been extracted from the plurality of pieces of content by the extraction means, as information indicating a feature of the subject that is described in the content from which the assertion point is extracted.

### (Supplementary Note C9)

The analysis program according to supplementary note C1, for causing the computer to further function as a feature information generation means, the plurality of pieces of content describing respective different subjects, from among respective assertion points that are asserted in the plurality of pieces of content, the extraction means extracting, as the comparison target portion, an assertion point dealing with a matter that is common between the plurality of pieces of content, and the feature information generation means generating feature information, with use of the assertion point that has been extracted from the plurality of pieces of content by the extraction means, the feature information indicating a feature that is common between the respective different subjects that are described in the plurality of pieces of content from which the assertion point is extracted.

### (Supplementary Note D1)

An information processing apparatus including at least one processor, the at least one processor carrying out: an acquisition process of acquiring a plurality of pieces of content which are comparison targets; and an extraction process of extracting, with use of an extraction model which has been generated by machine learning so as to be capable of extracting a comparison target portion in content, a comparison target portion in the plurality of pieces of content that have been acquired in the acquisition process.

The information processing apparatus may further include a memory. The memory may store a program for causing the at least one processor to carry out each of the processes.

### (Supplementary Note D2)

The information processing apparatus according to supplementary note D1, wherein, in the extraction process, from among respective assertion points that are asserted in the plurality of pieces of content, the at least one processor extracts, as the comparison target portion, at least one selected from the group consisting of (i) an assertion point dealing with a matter that is common between the plurality of pieces of content and (ii) an assertion point dealing with a matter that is different between the plurality of pieces of content.

### (Supplementary Note D3)

The information processing apparatus according to supplementary note D1, wherein, in the extraction process, from elements that are contained in the plurality of pieces of content, the at least one processor extracts, as the comparison target portion, each of elements that constitute a time series.

### (Supplementary Note D4)

The information processing apparatus according to supplementary note D3, wherein, in the extraction process, from reference information that describes the elements that constitute the time series, the at least one processor extracts an element that constitutes the time series together with the elements that have been extracted.

### (Supplementary Note D5)

The information processing apparatus according to supplementary note D3 or D4, wherein the at least one processor carries out a change information generation process of generating, for the elements that constitute the time series and that have been extracted in the extraction process, change information that indicates changes of the elements.

### (Supplementary Note D6)

The information processing apparatus according to supplementary note D5, wherein: in the change information generation process, the at least one processor generates the change information for each of a plurality of subjects; and the at least one processor carries out a presentation process of associating, with each other, respective pieces of the change information that correspond to the plurality of subjects and presenting the pieces of the change information.

### (Supplementary Note D7)

The information processing apparatus according to any one of supplementary notes D3 to D6, wherein the at least one processor carries out an integration process of generating new content in which the elements that constitute the time series and that have been extracted in the extraction process are integrated with each other.

### (Supplementary Note D8)

The information processing apparatus according to supplementary note D1, wherein: the plurality of pieces of content each describe a subject which is different for each of the plurality of pieces of content; in the extraction process, from among respective assertion points that are asserted in the plurality of pieces of content, the at least one processor extracts, as the comparison target portion, an assertion point dealing with a matter that is different between the plurality of pieces of content; and the at least one processor carries out a presentation process of presenting the assertion point that has been extracted from the plurality of pieces of content in the extraction process, as information indicating a feature of the subject that is described in the content from which the assertion point is extracted.

### (Supplementary Note D9)

The information processing apparatus according to supplementary note D1, wherein: the plurality of pieces of content describe respective different subjects; in the extraction process, from among respective assertion points that are asserted in the plurality of pieces of content, the at least one processor extracts, as the comparison target portion, an assertion point dealing with a matter that is common between the plurality of pieces of content; and the at least one processor carries out a feature information generation process of generating, with use of the assertion point that has been extracted from the plurality of pieces of content in the extraction process, feature information indicating a feature that is common between the respective different subjects that are described in the plurality of pieces of content from which the assertion point is extracted.

### (Supplementary Note E)

A non-transitory storage medium storing an analysis program for causing a computer to carry out: an acquisition process of acquiring a plurality of pieces of content which are comparison targets; and an extraction process of extracting, with use of an extraction model which has been generated by machine learning so as to be capable of extracting a comparison target portion in content, a comparison target portion in the plurality of pieces of content that have been acquired in the acquisition process.

### REFERENCE SIGNS LIST

1 information processing apparatus
101 acquisition unit (acquisition means)
102 extraction unit (extraction means)
1A information processing apparatus
101A acquisition unit (acquisition means)
102A extraction unit (extraction means)
103A presentation unit (presentation means)
104A change information generation unit (change information generation means)
106A integration unit (integration means)
107A feature information generation unit (feature information generation means)
111A extraction model

1. An information processing apparatus comprising at least one processor, the at least one processor carrying out:
an acquisition process of acquiring a plurality of pieces of content which are comparison targets; and
an extraction process of extracting, with use of an extraction model which has been generated by machine learning so as to be capable of extracting a comparison target portion in content, a comparison target portion in the plurality of pieces of content that have been acquired in the acquisition process.

2. The information processing apparatus according to claim 1, wherein, in the extraction process, from among respective assertion points that are asserted in the plurality of pieces of content, the at least one processor extracts, as the comparison target portion, at least one selected from the group consisting of (i) an assertion point dealing with a matter that is common between the plurality of pieces of content and (ii) an assertion point dealing with a matter that is different between the plurality of pieces of content.

3. The information processing apparatus according to claim 1, wherein, in the extraction process, from elements that are contained in the plurality of pieces of content, the at least one processor extracts, as the comparison target portion, each of elements that constitute a time series.

4. The information processing apparatus according to claim 3, wherein, in the extraction process, from reference information that describes the elements that constitute the time series, the at least one processor extracts an element that constitutes the time series together with the elements that have been extracted.

5. The information processing apparatus according to claim 3, wherein the at least one processor carries out a change information generation process of generating, for the elements that constitute the time series and that have been extracted in the extraction process, change information that indicates changes of the elements.

6. The information processing apparatus according to claim 5, wherein:
in the change information generation process, the at least one processor generates the change information for each of a plurality of subjects; and
the at least one processor carries out a presentation process of associating, with each other, respective pieces of the change information that correspond to the plurality of subjects and presenting the pieces of the change information.

7. The information processing apparatus according to claim 3, wherein the at least one processor carries out an integration process of generating new content in which the elements that constitute the time series and that have been extracted in the extraction process are integrated with each other.

8. The information processing apparatus according to claim 1, wherein:
the plurality of pieces of content each describe a subject which is different for each of the plurality of pieces of content;
in the extraction process, from among respective assertion points that are asserted in the plurality of pieces of content, the at least one processor extracts, as the comparison target portion, an assertion point dealing with a matter that is different between the plurality of pieces of content; and
the at least one processor carries out a presentation process of presenting the assertion point that has been extracted from the plurality of pieces of content in the extraction process, as information indicating a feature of the subject that is described in the content from which the assertion point is extracted.

9. An analysis method comprising:
an acquisition process in which at least one processor acquires a plurality of pieces of content which are comparison targets; and
an extraction process in which the at least one processor extracts, with use of an extraction model which has been generated by machine learning so as to be capable of extracting a comparison target portion in content, a comparison target portion in the plurality of pieces of content that have been acquired in the acquisition process.

10. A computer-readable non-transitory storage medium storing an analysis program for causing a computer to carry out:
an acquisition process of acquiring a plurality of pieces of content which are comparison targets; and
an extraction process of extracting, with use of an extraction model which has been generated by machine learning so as to be capable of extracting a comparison target portion in content, a comparison target portion in the plurality of pieces of content that have been acquired in the acquisition process.
